(19) United States
(12) Patent Application Publication
(10) Pub. No.: US 2010/0097700 A1
(43) Pub. Date: Apr. 22, 2010

(54) LASER DIODE EMITTER POWER CONCENTRATION ENHANCEMENT

(76) Inventors: Kobi Goldstein, Lapid (IL); Haim Chayet, Nes Niona (IL)

Correspondence Address: David A. Novais;Patent Legal Staff, Eastman Kodak Company, 343 State Street, Rochester, NY, 14650-2201, US

(21) Appl. No.: 11/764,244

(22) Filed: Jun. 18, 2007

(51) Int. Cl. G02B 27/28

(52) U.S. Cl. 359/485

(57) ABSTRACT

A method of coupling laser radiation from a single emitter to achieve an increased power concentration on a radiated area comprising the steps of: providing a laser diode emitter (11) emitting laser radiation; splitting the laser radiation into a first beam (10a) and a second beam (10b); rotating a polarization of the first beam; optically combining the first beam and the second beam into a combined laser radiation beam; and directing the combined laser beam on an imaging media (22).

### FIELD OF THE INVENTION

This present invention relates to concentrating laser diode radiation from a laser emitter by splitting and combining laser radiation from a single emitter diode laser.

### BACKGROUND OF THE INVENTION

Solid state diode-laser emitters are available with typical aperture width, ranging from 50 micro meter up to few hundreds micro meters. The aperture height of such diode-lasers are about 1 micro meter. Each diode-laser emitter, emits a laser beam which diverges quickly in the height direction of the emitting aperture, also called fast axis direction. Perpendicular to the fast axis, the laser beam is diverging slowly in the width direction of the diode-laser aperture, also called slow axis direction.

In commercial application where a small laser spot emission is required, diode-lasers with small aperture width will be used. In graphic arts applications, for example, where fine detail resolution is practically a must, in order to achieve high quality printing, the smallest diode-laser aperture width will be typically used.

Often the power concentration emitted from a single laser diode is not sufficient. In order to overcome this deficiency certain technique might be applied. U.S. Pat. No. 7,010,194 (Anikitchev et al.) describes a method and apparatus for coupling radiation from a stack of diode-laser bars into a single core optical fiber. U.S. Pat. No. 7,010,194 teaches combining the laser radiation emitted from two distinct diode-lasers into a single core. The power concentration is achieved by altering the laser beam polarity emitted from one diode-laser, and combining it with the laser beam emitted from a second diode-laser into a single fiber core, thus resulting with a higher power concentration beam.

The invention below increases the power concentration of a single diode-laser by applying optical elements is described.

### SUMMARY OF THE INVENTION

Briefly, according to one aspect of the present invention a method of laser radiation is concentrated from a laser emitter having a first surface area into a second area, wherein the second area is less than the first surface area. A first portion of the laser radiation from the laser emitter is rotated. The rotated laser radiation is passed through a selective mirror. A second portion of the laser radiation from the laser emitter is reflected from a reflective mirror. The reflected radiation is combined with the first portion of the laser radiation.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic illustrating beam splitting of a single laser diode emitter and combining the two parts into a single optical path.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

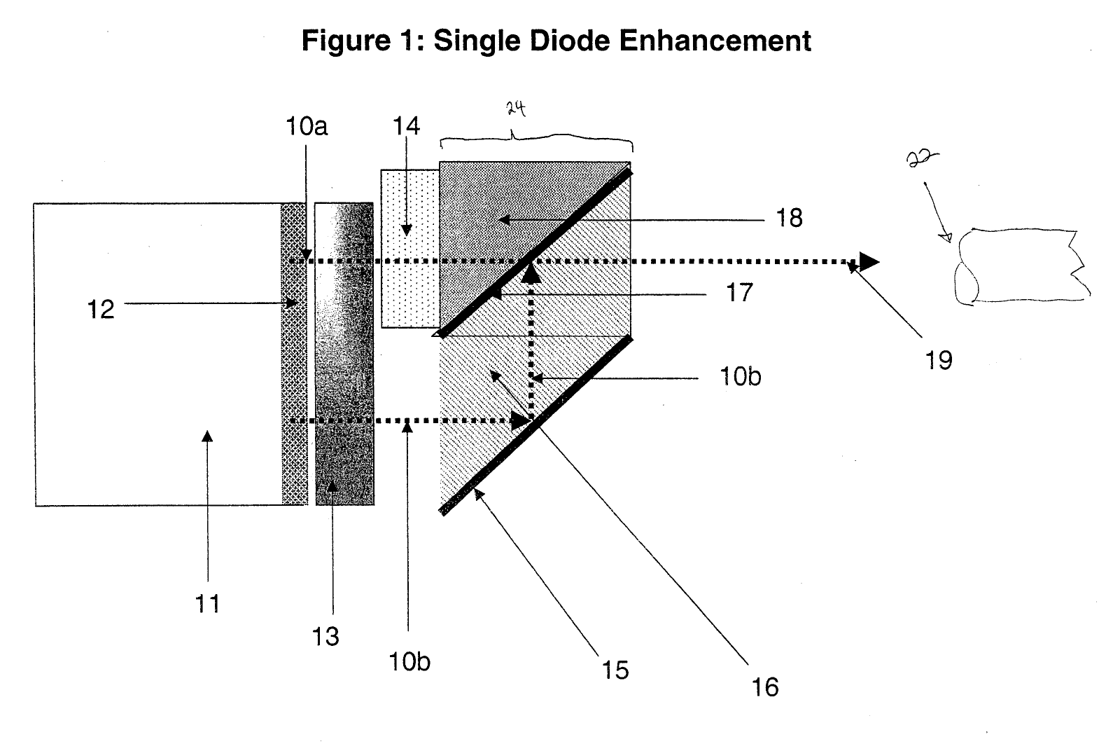

FIG. 1 schematically illustrates a beam combining apparatus in accordance with the present invention. The apparatus includes a solid state broad area laser diode having a single emitting region in the shape of a strip with short dimension typically of 1 um, and long dimension that can be 100 μm, 200 μm or larger. For example a 1×100 μm emitter laser diode is available from JDSU p/n 6397-L3 Series

http://www.jdsu.com/index.cfm?productid=617&pagepath=Products/Commercial_Lasers/Products/Diode_Lasers&id=2008.

Because of the geometrical asymmetry of the emitter, the beam properties are also different for the two directions:
In the short direction, the beam is essentially diffraction-limited.
The small aperture size leads to considerable beam divergence in this direction, which typically can be of 60 degree angle containing for 90% of the radiant energy. Because of fast divergence, this direction is frequently referred to as the “fast axis” direction.
In the long direction, the stripe width may be 100 μm, 200 μm, or larger. Although in this direction that the light is distributed over many spatial modes and the beam divergence is much larger than for a diffraction-limited beam with that size, it is still significantly smaller than for the fast axis direction, with much smaller dimensions. This is called the “slow axis” direction with typical angular values of 10° containing 90% of the energy of the remaining energy.

The active region of a laser diode is formed from strained semiconductor layer, or several layers. Because of the strain the electrical properties of the semiconductor are anisotropic, that is, different in the direction parallel to the layer, and the direction perpendicular to it. Such anisotropy is manifested, for example, in a preferred direction of the electrical conductivity. As a result, the radiation emitted from the laser is linearly polarized, the electric field oscillates in a certain stable direction perpendicular to the propagation direction of the laser beam. With the slow axis considerably larger than the fast axis, the vector of polarization lies predominantly in a direction either perpendicular to the active region of the laser diode, or parallel to it. In the first case the polarization is essentially parallel to the fast axis, in the former the polarization is essentially in a direction of the slow axis.

The light emitted from the laser emitter 11 through emitting aperture 12 and collimating lens 13 will first enter through fast axis collimating lens 13. The laser radiation beams 10a, 10b will enter into a composite prism 24 comprising a rectangular parallelepiped prism 16 bonded together with a triangle prism 18. At the bonding surface a polarized selective mirror 17 is formed by applying a multilayer dielectric coating before bonding prism 16 to prism 18.

Reflected mirror 15 is located on the external face of prism 16. Mirrors 15 and 17 are highly reflective for radiation having the wavelength of the diode laser radiation. A polarization rotating device 14 is placed in the path of the emitted laser radiation beam 10a, and is optionally bonded to prism 18.

The laser radiation beam 10a will traverse via the polarization rotating device 14. The polarization rotated laser radiation beam 10a enters prism 18 and is transmitted through polarization selective mirror 17 and prism 16 along the original propagation path emitted from the laser diode 11.

The laser radiation beam 10b enters prism 16 and is reflected by mirror 15 perpendicular to the original propagation path. Laser radiation beam 10b then hits polarized selective mirror 17 and is reflected along the original propagation path of laser radiation beam 10a. Thus, a combined beam 19 is formed into a single beam combining laser radiation beams 10a and 10b. The combined beam power concentration is significantly greater than either of the original laser radiation beam 10a, 10b and is directed to an imaging media 22.

The invention has been described in detail with particular reference to certain preferred embodiments thereof, but it will be understood that variations and modifications can be effected within the scope of the invention.

### PARTS LIST

10a laser radiation beam
10b laser radiation beam
11 laser emitter
12 emitting aperture
13 collimating lens
14 polarization rotating device
15 reflective mirror
16 prism
17 selective mirror
18 prism
19 combined beam
22 media
24 composite prism

1. A method of coupling laser radiation from a single emitter to achieve an increased power concentration on a radiated area comprising the steps of:
a) providing a laser diode emitter emitting laser radiation;
b) splitting said laser radiation into a first beam and a second beam;
c) rotating a polarization of said first beam;
d) optically combining said first beam and said second beam into a combined laser radiation beam; and
e) directing the said combined laser beam on an imaging media.

2. A method of concentrating laser radiation from a laser emitter having a first surface area onto a second area, wherein the second area is less than the first surface area, comprising:
rotating a first portion of the laser radiation from the laser emitter;
passing the rotated laser radiation through a selective mirror;
reflecting a second portion of the laser radiation from the laser emitter from a reflective mirror; and
reflecting the second portion of the laser radiation from the selective mirror and combining the second portion of the laser radiation with the first portion of the laser radiation.

3. An apparatus for concentrating radiation from a laser emitter comprising:
a collimating lens adjacent a surface of the emitter;
a polarization rotating lens adjacent a first portion of the collimating lens which polarizes the collimated laser radiation;
a selective mirror adjacent the polarization rotating lens, wherein polarized laser radiation passes through the selective mirror;
a reflector adjacent a second portion of the collimating lens which reflects the collimated laser radiation to the selective mirror; and
wherein the selective mirror reflects the collimated laser radiation along an axis parallel to the polarized laser radiation.

4. A method of coupling laser radiation from a single emitter to achieve an increased power concentration on a radiated area comprising the steps of:
a) providing a laser diode emitter emitting laser radiation;
b) splitting said laser radiation into a first beam and a second beam;
c) rotating a polarization of said first beam; and
d) optically combining said first beam and said second beam into a combined laser radiation beam.
